(19) United States
(12) Patent Application Publication
(10) Pub. No.: US 2021/0086854 A1
(43) Pub. Date: Mar. 25, 2021

(54) Assembly Device for Inserting a Stator of an Electric Machine into a Transmission Housing, Hybrid Drive Module, and Method for Mounting a Stator

(71) Applicant: ZF Friedrichshafen AG, Friedrichshafen (DE)

(72) Inventors: Andreas Jung, Schlier (DE); Matthias Weidner, Wasserlosen (DE); Thomas Riedisser, Sigmarszell (DE); Florian Pöhnlein, Weildorf (Salem) (DE); Peter Fenn, Waigolshausen (DE); Linus Eschenbeck, Wangen (DE)

(21) Appl. No.: 17/025,436

(22) Filed: Sep. 18, 2020

(30) Foreign Application Priority Data
Sep. 20, 2019 (DE) 10 2019 214 349.0

(51) Int. Cl. B62D 65/02; F16H 57/02; B62D 65/10; H02K 7/00; H02K 7/108; H02K 7/116

(52) U.S. Cl. CPC B62D 65/026; F16H 57/02; B62D 65/10; F16H 2057/0062; H02K 7/108; H02K 7/116; H02K 7/006

(57) ABSTRACT

An assembly device (29) for inserting a stator (4) of an electric machine (3) into a bell-shaped transmission housing (1) includes an inner guide element (38), which is guidable, in form-locking manner, relative to a rotor hub (9a) or a transmission input shaft (6) accommodating the rotor hub (9a), and an outer guide element (37), which is guidable in form-locking manner at the transmission housing (1). The guide elements (37 and 38) are radially spaced apart and fixed to each other with at least one radially extending connecting element (39). At least one sliding member (30) is longitudinally displaceably guided in the connecting element (39) and includes a first, radially outer sliding member part (31) for form-locking engagement at an outer circumference of the stator (4) and a second, radially inner sliding member part (32) for engagement at an end face of the stator (4).

### CROSS-REFERENCE TO RELATED APPLICATION

The present application is related and has right of priority to German Patent Application No. 10 2019 214 349.0 filed on Sep. 20, 2019, which is incorporated by reference in its entirety for all purposes.

### FIELD OF THE INVENTION

The invention relates generally to an assembly device for inserting a stator of an electric machine, which is an integral part of a hybrid drive module, into a bell-shaped transmission housing, wherein a rotor of the electric machine is at least indirectly connected, via a rotor carrier as well as a rotor hub, to a transmission input shaft, and a stator of the electric machine, extending concentrically to the rotor and radially surrounding the rotor, is securable at the transmission housing.

Moreover, the invention also relates generally to a hybrid drive module and an assembly device for inserting a stator of an electric machine, which is an integral part of the hybrid drive module, into a bell-shaped transmission housing, which radially surrounds the hybrid drive module, wherein a rotor of the electric machine is at least indirectly connected, via a rotor carrier as well as a rotor hub, to a transmission input shaft, and a stator of the electric machine, extending concentrically to the rotor and radially surrounding the rotor, is secured at the transmission housing.

Finally, the invention also relates generally to a method for mounting a stator of an electric machine, which is an integral part of a hybrid drive module, into a bell-shaped transmission housing, into which a rotor has already been inserted.

### BACKGROUND

With respect to a type of hybrid drive train of a motor vehicle, the electric machine is arranged in a part of a transmission housing designed in the form of a clutch bell housing, wherein a stator of the electric machine is inserted into the clutch bell housing of the transmission housing in a rotationally fixed manner. A rotor of the electric machine, which is centrally arranged within the stator, is connected to a primary part of a torque converter in an automatic transmission and, in a manual transmission, is connected to a clutch unit, which is formed by a multi-disk clutch.

In order to achieve a compact, installation space-saving arrangement, upon utilization of a multi-disk clutch, the clutch disk pack and a clutch actuating unit can be arranged, viewed spatially, radially within the extension of the rotor. With a torque converter, the radial space within the rotor is utilized for accommodating a torque converter lockup clutch. The clutch bell housing is closed toward the internal combustion engine with the aid of a bearing shield.

A bell-shaped transmission housing, which accommodates, in an interior of the bell-shaped transmission housing, a hybrid drive module essentially made of an electric machine and a torque converter or at least one separating clutch, is known from the document DE 10 2018 200 569 B3. In that case, a bearing shield, which is flange-mounted onto the transmission housing and is secured via bolts, is fitted into the transmission housing via an axially extending, sleeve-like section, which accommodates a stator of the electric machine. In addition, the bearing shield is provided with a precentering unit for facilitating the mounting of the hybrid module onto a crankshaft of an internal combustion engine. The bearing shield separates a wet space of the hybrid drive module from a dry space, wherein the seal of the wet space with respect to the dry space takes place with the aid of a sealing ring, which is arranged in the bearing shield and directly next to the precentering unit.

In addition, DE 10 2017 218 743 A1 describes a method for connecting a torque converter unit to a transmission, wherein the torque converter unit is an integral part of a hybrid drive module. In a first exemplary embodiment, a rotor of an electric machine is connected via a rotor carrier to the torque converter unit, and the rotor carrier accommodating the rotor extends, starting from a torque converter shell, in the axial direction. Before the assembly process is carried out, a stator of the electric machine is mounted at a fixing plate, which extends transversely to a shaft arrangement of the hybrid drive module and is connected to a transmission housing. The torque converter unit and, therefore, the rotor are inserted into the transmission housing with the aid of an assembly fixture, which engages at the torque converter unit via a first assembly tool and a second assembly tool with opposing forces. The first assembly tool is accommodated by a groove of an input section of the torque converter. The second assembly tool rests against the torque converter shell via an offset compensation element. In this way, the torque converter unit is grasped at an end face of the torque converter unit by the assembly device and can be inserted into the interior of the bell-shaped transmission housing. In the installed condition, the rotor surrounds the radially inward lying stator. One further exemplary embodiment differs from the previously explained exemplary embodiment in terms of the arrangement of the rotor, which is surrounded by the stator fixed in the transmission housing.

### SUMMARY OF THE INVENTION

Example aspects of the present invention create an assembly device for an arrangement of a hybrid drive module having the features of a generic type, with the aid of which a reliable installation of the stator is made possible, once an essential component of the hybrid drive module, which is connected to the rotor, has been arranged within the transmission housing.

Accordingly, an assembly device is utilized for inserting a stator of an electric machine into a bell-shaped transmission housing. The electric machine, which is an integral part of a hybrid drive module, includes a rotor, which is at least indirectly connected to a transmission input shaft via a rotor carrier and a rotor hub. In addition, a stator of the electric machine, extending concentrically to the rotor and radially surrounding the rotor, is securable at the transmission housing.

According to example aspects of the invention, the assembly device includes an inner guide element, which is intended to be guided, in a form-locking manner, with respect to the rotor hub or at least indirectly with respect to the transmission input shaft accommodating the rotor hub. Another integral part of the assembly device is an outer guide element, with the aid of which the assembly device is guided, in a form-locking manner, at the transmission housing. The two guide elements are radially spaced apart from each other and are fixed to each other with the aid of at least one radially extending connecting element. At least one sliding member is longitudinally displaceably guided in the connecting element, wherein the sliding member includes two sliding member parts, which are adjustable with respect to each other, of which a first, radially outer sliding member part is provided for a form-locking engagement at the outer circumference of the stator and a second, radially inner sliding member part is provided for an engagement at an end face of the stator.

With the aid of the two guide elements, therefore, the transmission input shaft including the rotor is centerable with respect to the transmission housing, on the one hand, and the assembly device can be aligned at the transmission housing, on the other hand. Therefore, the assembly device engages, in a form-locking manner, at the transmission housing as well as at the transmission input shaft. This does not need to be a direct engagement at the transmission input shaft; instead, the inner guide element, which is preferably designed, at least partially or in sections, as a sleeve, can also enclose a hub or hollow shaft arranged on the transmission input shaft.

The connecting element extending radially between the guide elements can be designed as a disk, wherein at least one opening is provided in the disk for accommodating the at least one sliding member, which is moved in parallel to the longitudinal central axis of the overall arrangement. The two sliding member parts are movable with respect to each other in such a way that the stator is grasped thereby and is brought into a certain position—with regard to the radial position and the position in the direction of rotation—with respect to the transmission housing. Alternatively to the design of the connecting element as a disk, the connecting element can also be designed including individual radially extending struts.

In one further example embodiment of the present invention, it is provided that centering pins extend axially from the outer guide element, wherein the centering pins are provided for an engagement in through-bores of the transmission housing, which extend in a mounting flange formed at the transmission housing. These centering pins are therefore utilized for centering the assembly device and the stator accommodated by the assembly device with respect to the transmission housing, wherein the centering pins are introduced into the appropriate bore holes, which are preferably designed as through-bores. The bore holes can be structurally provided for a subsequent fixing of a bearing shield at the transmission housing.

In addition, it is provided that the second sliding member part is provided for a form-locking engagement into the end face of the stator, whereby the stator, in a certain rotational position with respect to the transmission housing, is insertable into the transmission housing. The second sliding member part can be provided with positioning pins extending in the axial direction, which are provided for an engagement in centering bore holes of the stator.

The form-locking engagement of the first sliding member part at the outer circumference of the stator can be designed, in a further example embodiment of the invention, in such a way that the first sliding member part is couplable, in the manner of a bayonet, to a driving surface provided at the outer circumference of the stator. The driving surface is formed, in this case, by individual surface segments protruding radially above the outer circumference of the stator and pointing in the axial direction, wherein engaging pieces provided at the first sliding member part and directed radially inward are turned into a position in which the engaging pieces engage behind the individual surface segments and, in this way, fix the stator between themselves and the positioning pins.

In addition, the first sliding member part and the second sliding member part can each be designed, at least partially or in sections, to be hollow-cylindrical, wherein the second sliding member part is displaceably guided in the first sliding member part, and wherein claws extending in the axial direction protrude from the first sliding member part.

Example aspects of the invention also provide a hybrid drive module and an assembly device for inserting a stator into a bell-shaped transmission housing radially surrounding the hybrid drive module. The stator is an integral part of an electric machine provided in the hybrid drive module. A rotor of the electric machine is at least indirectly connected to a transmission input shaft via a rotor carrier and a rotor hub, while its stator, extending concentrically to the rotor and radially surrounding the rotor, is secured at the transmission housing.

According to example apsects of the invention, the assembly device is to include an inner guide element, which is guided, during an assembly process, in a form-locking manner with respect to the rotor hub or the transmission input shaft accommodating the rotor hub. In addition, the assembly device is guided, in a form-locking manner, at the transmission housing with the aid of an outer guide element, wherein the two guide elements are radially spaced apart from each other and are fixed to each other with the aid of at least one radially extending connecting element. At least one sliding member designed as a dog or claw is longitudinally displaceably guided in the connecting element and accommodates the stator and guides the stator with respect to the rotor hub and/or the transmission input shaft as well as with respect to the transmission housing.

With respect to the hybrid drive module and the assembly device cooperating therewith, in addition, the sliding member is to include two sliding member parts, which are adjustable with respect to each other, of which a first, radially outer sliding member part engages in a form-locking manner at the outer circumference of the stator and a second, radially inner sliding member part engages at an end face of the stator.

In addition, the stator is to include bulges at an external shell surface of the stator, which extend, in the manner of ribs, across a substantial portion of the axial length of the stator and form bolting-on surfaces at rear-side ends of the bulges, wherein tabs extending in the circumferential direction protrude from a front section of the bulges and are each engaged from behind at a driving surface by the outer sliding member part. At the end of the assembly process, the stator is secured, via these bulges, which are provided in laminated cores of the stator, at bolting-on surfaces of the transmission housing, which is why through-bores extend within the bulges. A tab protrudes from each of these bulges, which is preferably designed having a shorter axial length than the bulge, wherein an end face of the tab is engaged from behind by the particular engaging piece of the first sliding member part.

In addition, the tabs are to include centering bore holes extending in the axial direction, into which positioning pins of the second sliding member part and locating pins extending from the transmission housing in the mounted condition of the stator engage during the assembly process. The centering bore holes penetrate the tabs and are designed to be slightly longer than the positioning pins, and so the centering bore holes can be threaded onto the centering pins from one end, although the positioning pins of the second sliding member part are engaged at the other end. In addition, the assembly device can be designed in the previously explained way.

Example aspects of the invention also provide a method for installing a stator of an electric machine, which is an integral part of a hybrid drive module, into a bell-shaped transmission housing. A rotor has already been inserted into the transmission housing in this case.

According to example aspects of the invention, the stator is initially grasped by two sliding member parts of an assembly device at an end face and at a driving surface provided at the outer circumference of the stator, and is aligned in the radial direction as well as in the circumferential direction with respect to the assembly device. The latter takes place with the aid of positioning pins, which engage into centering bore holes of tabs.

In a second method step, the assembly device is then centered in front of the end of the transmission housing, wherein an outer guide element is aligned with the aid of bore holes provided in a flange of the transmission housing, and a rotor hub and/or transmission input shaft are/is centered at an inner guide element.

In a third method step, a sliding member formed by the two sliding member parts displaces the stator into the radial space between the rotor and the transmission housing until the centering bore holes provided at the stator have been slid onto centering pins, which protrude from the transmission housing.

In a fourth method step, the stator is bolted to the transmission housing with the aid of axially extending bolts. Appropriate bore holes for accommodating the bolts extend next to the centering bore holes, in parallel thereto.

Finally, in a fifth method step, the assembly device is initially separated from the stator and, thereafter, from the transmission housing and the rotor hub and/or the transmission input shaft.

The invention is not limited to the specified combination of features of the independent claims and the claims dependent thereon. In addition, individual features can be combined with one another, provided they arise from the claims, the description of preferred embodiments of the invention which follows, or directly from the drawings. References in the claims to the drawings via the use of reference signs is not intended to limit the scope of protection of the claims.

### BRIEF DESCRIPTION OF THE DRAWINGS

One advantageous embodiment of the invention, which is explained in the following, is represented in the drawings. Wherein:

FIG. 1 shows a part view including a longitudinal section through a transmission housing including a hybrid drive module arranged therein, which essentially includes an electric machine, a separating clutch, and a pre-ratio stage,

FIG. 2 shows, as a part view, a schematic related to the alignment and fixation of the stator in the transmission housing,

FIG. 3 shows a perspective representation of the stator, wherein the sliding member parts of the assembly device are placed onto the stator, as illustrated with the aid of a direction arrow,

FIG. 4 shows a perspective representation of the stator in the area of a radial bulge,

FIG. 5 shows, as a schematic, the fixation of the stator in the sliding member of the assembly device,

FIG. 5a shows the assembly device, which engages at the transmission housing and, via a hollow shaft, at a transmission input shaft,

FIG. 5b shows the threading of the stator onto centering pins, which are arranged in the transmission housing,

FIG. 5c shows the insertion of mounting bolts into the stator and a bracing of the stator with the transmission housing, and

FIG. 5d shows the separation of the assembly device from the stator, the transmission input shaft, and the transmission housing.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

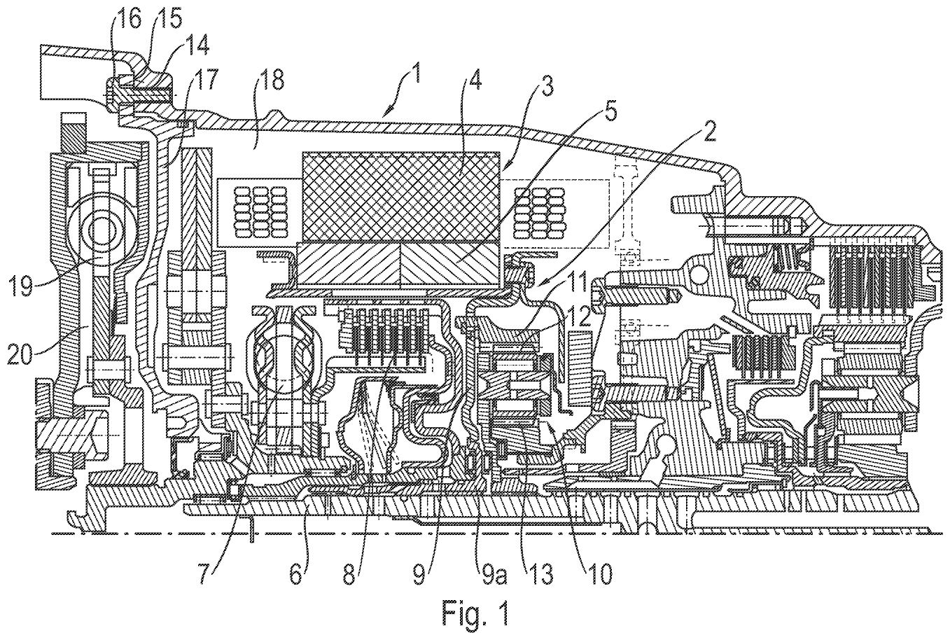

In FIG. 1, a front section of a transmission housing is labeled by 1; the front section is designed to be bell-shaped in the manner of a clutch housing, in order to be bolted to a crankcase (not described in greater detail) of an internal combustion engine. The transmission housing 1 accommodates, in an interior of the transmission housing 1, a hybrid drive module 2, which includes an electric machine 3 with a stator 4, which is rotationally fixed with respect to the transmission housing 1, and a rotary rotor 5. A further integral part of the hybrid drive module 2 is a transmission input shaft 6 for a transmission (not represented in greater detail) positioned downstream from the hybrid drive module 2, wherein a torsion damper 7 and a hydraulically actuated separating clutch 8 designed as a multi-disk clutch are mounted on the transmission input shaft 6. A rotor carrier 9 connected to the rotor 5 drives a planetary gear stage 10, which includes a ring gear 11 connected to the rotor carrier 9 in a form-locking manner, planet gears 12, and a sun gear 13, wherein the rotor carrier 9 is arranged via a rotor hub 9a on the transmission input shaft 6.

In addition, it is apparent from FIG. 1 that the transmission housing 1 is provided with multiple through-bores 14, which are distributed around a circumference of the transmission housing 1, as well as with a mounting face 15. With the aid of internal hexagon bolts 16, a bearing shield 17 is braced at the mounting face 15 with the transmission housing 1. Located on one side of the bearing shield 17 is a wet space 18 accommodating the hybrid drive module 2 and the planetary gear stage 10 and, located on the other side is a dry space 20, in which a dual-mass flywheel 19, among other things, is located. Before the mounting of the stator 4, which is explained in the following, the assembly including the rotor 5, the rotor carrier 9, and the planetary gear stage 10, are slid onto the transmission input shaft 6.

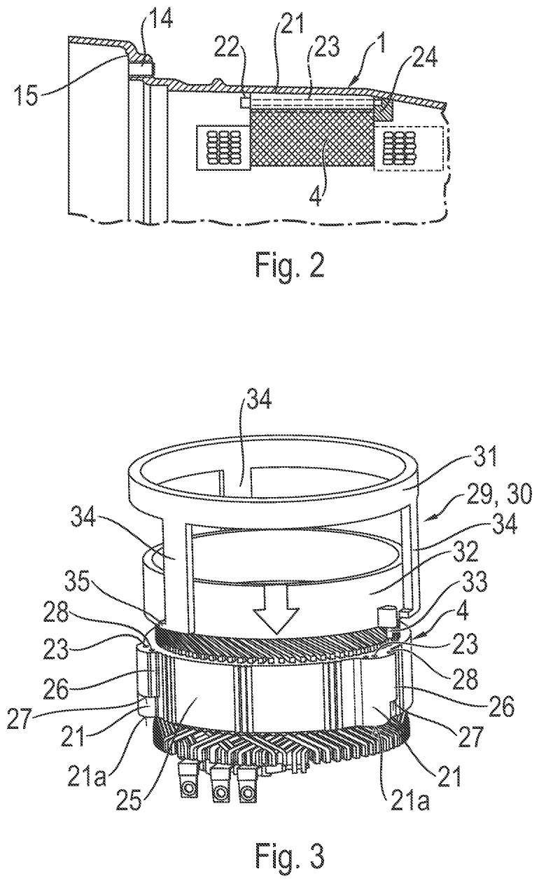

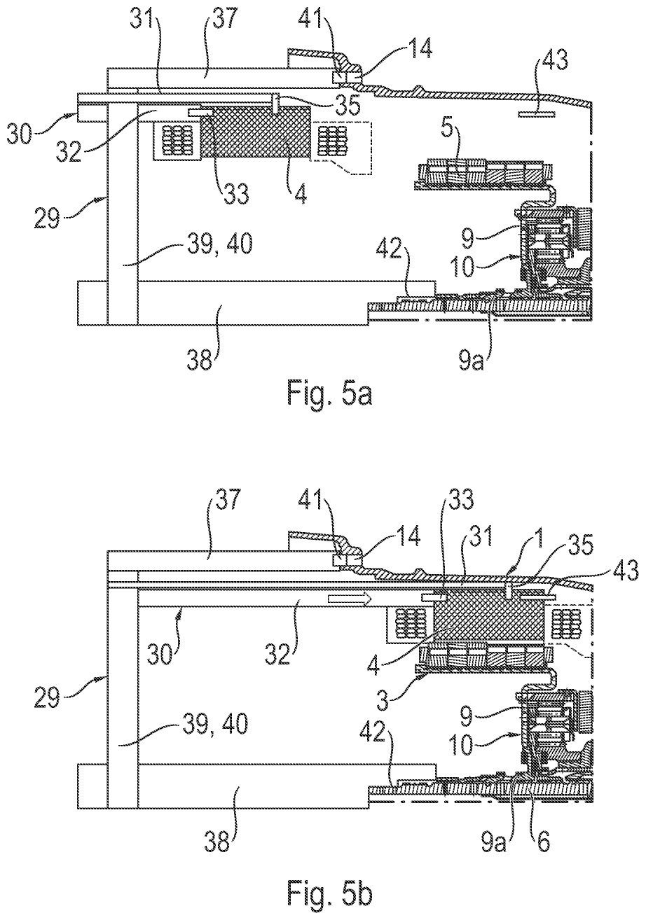

In FIG. 2, an upper subsection of the transmission housing 1 is diagrammatically represented, in order to illustrate how the stator 4 is to be secured therein. Accordingly, the stator 4—as is explained in detail in the following in conjunction with FIG. 4—includes multiple bulges 21 at an outer circumference of the stator 4, through which bore holes 23 accommodating mounting bolts 22 extend. Inwardly projecting flange segments 24 protrude from the transmission housing 1, into which the mounting bolts 22 engage with the aid of their external thread.

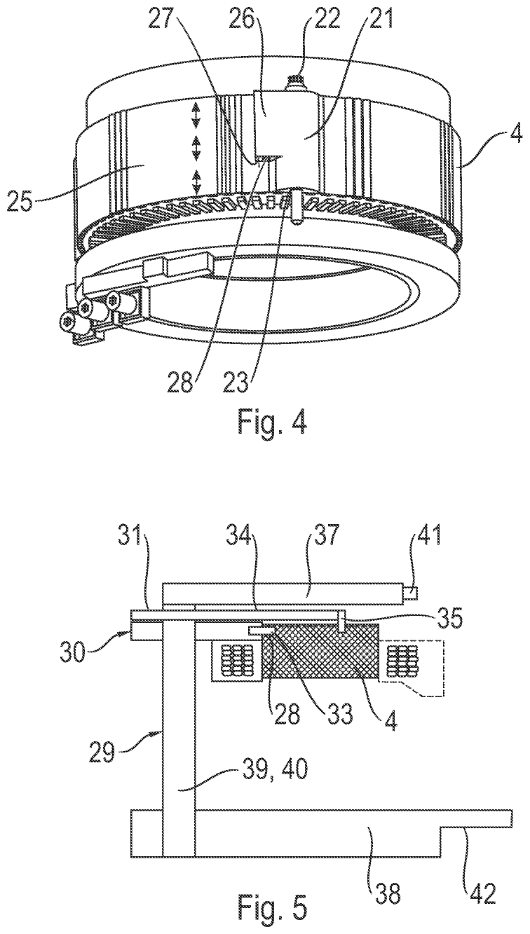

FIG. 3 shows the stator 4, from whose laminated cores 25 the radially outward projecting bulges 21 protrude, which extend along the axial length of the laminated cores 25. Each of the bulges 21 includes a bore hole 23. Tabs 26, which have a shorter axial length as compared to the bulges 21, are located next to the bulges 21 on the external shell surface of the laminated cores 25. As a result, driving surfaces 27 are formed at the tabs 26. For the rest, centering bore holes 28 extend through the tabs 26.

In FIG. 3, an assembly device 29 is placed onto the stator 4, of which a sliding member 30 is visible in the representation; the sliding member 30 is constructed of a hollow-cylindrical, first sliding member part 31 and a likewise hollow-cylindrical, second sliding member part 32. The second sliding member part 32 is longitudinally displaceably guided in the first sliding member part 31 and includes positioning pins 33, with the aid of which the stator 4 is aligned with respect thereto in the circumferential direction, in that the positioning pins 33 engage into the centering bore holes 28 of the tabs 26. Axial extensions 34, at the ends of which engaging pieces 35 are located, are an integral part of the first sliding member part 31. Initially, the first sliding member part 31 is moved axially to such an extent that the engaging pieces 35 are located in a plane with the driving surfaces 27 of the tabs 26. Thereafter, a turn of the first sliding member part 31 takes place, and so the engaging pieces 35 engage, in the manner of bayonets, at the tabs 26. Therefore, the stator is fixed at an end face of the tabs 26 and, on the other hand, at the driving surfaces 27.

FIG. 4 shows the stator 4 without the assembly device 29 placed thereon, and so the configuration of the bulges 21 is made clear. Mounting bolts 22 have already been inserted into the bore holes. With respect to a tab 26 represented in FIG. 4, it is apparent that the tab 26 is designed to be shorter than the bulge 21, whereby the driving surface 27 is formed at this end. In addition, a centering bore hole 28 is apparent from this view.

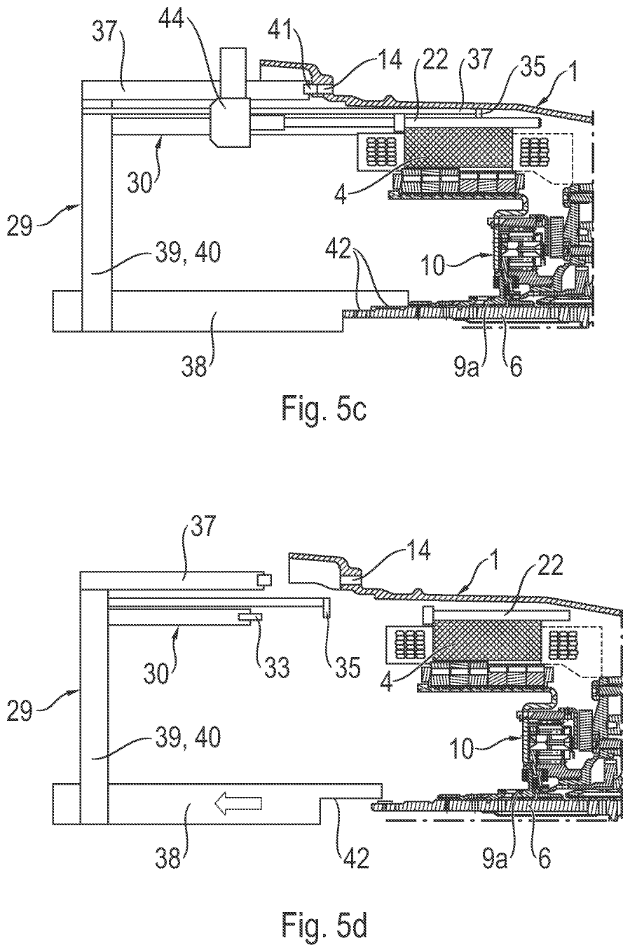

In FIGS. 5 and 5a-5d, individual method steps of a method for mounting the stator 4 of the electric machine 2 are represented. As is apparent from these figures, the assembly device 29 includes an outer guide element 37 and an inner guide element 38, which are connected to each other with the aid of a connecting element 39 extending radially therebetween. The connecting element 39 is designed as a disk 40. As is also apparent, centering pins 41, which extend axially, protrude from the outer guide element 37. The inner guide element 38 includes a recess 42. In addition, the sliding member 30 is longitudinally displaceably guided in the connecting element 39, wherein the sliding member 30 includes the first sliding member part 31 and the second sliding member part 32. The positioning pins 33 engage into the stator 4 on the end face, which takes place via the centering bore holes 28, as explained above.

The engaging pieces 35 formed at the extensions 34 of the first sliding member element 31 can be pivoted so far that the engaging pieces 35 can engage behind the driving surfaces 27. Thereafter, the assembly device 29, together with the stator grasped thereby, is centered in front of the end of the transmission housing 1. As a result, the centering pins 41 are inserted into the bore holes 14 and the inner guide element 38 indirectly engages at the transmission input shaft 6, in order to be centered at the transmission input shaft 6 and the drive elements arranged thereon, and, therefore, according to FIG. 5a, centers the transmission input shaft 6 and the units—planetary gear stage 10 and rotor 5-arranged thereon, with respect to the transmission housing 1. In addition, it is apparent from the representation according to FIG. 5a that multiple axially extending locating pins 43 are arranged therein.

According to FIG. 5b, the stator 4 is then slid, with the aid of the sliding member 30 of the assembly device 29, into the annular space formed between the rotor 5 and the transmission housing 1, wherein the locating pins 43 engage into the centering bore holes 28. According to FIG. 5c, the mounting bolts 22 are then screwed into the flange segments 24 (see FIG. 2) with the aid of a wrench 44. According to FIG. 5d, finally, a separation of the assembly device 29 from the transmission housing 1 and the stator 4 takes place.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE NUMBERS

1 transmission housing
2 hybrid drive module
3 electric machine
4 stator
5 rotor
6 transmission input shaft
7 torsion damper
8 hydraulically actuated separating clutch
9 rotor carrier
9a rotor hub
10 planetary gear stage
11 ring gear
12 planet gear
13 sun gear
14 through-bores
15 mounting face
16 internal hexagon bolt
17 bearing shield
18 wet space
19 dual-mass flywheel
20 dry space
21 bulge
21a bolting-on surface of 21
22 mounting bolt
23 bore hole
24 flange segment
25 laminated cores
26 tab
27 driving surface
28 centering bore hole
29 assembly device
30 sliding member
31 first sliding member part
32 second sliding member part
33 positioning pin
34 extensions
35 engaging piece
36 end face of 26
37 outer guide element
38 inner guide element
39 connecting element
40 disk
41 centering pin
42 recess in 38
43 locating pin
44 wrench

1-11. (canceled)

12. An assembly device (29) for inserting a stator (4) of an electric machine (3) of a hybrid drive module (2) into a bell-shaped transmission housing (1), a rotor (5) of the electric machine (3) at least indirectly connected to a transmission input shaft (6) via a rotor carrier (9) and a rotor hub (9a), a stator (4) of the electric machine (3) extending concentrically to the rotor (5), radially surrounding the rotor (5), and securable at the transmission housing (1), the assembly device (29) comprising:
an inner guide element (38) guidable, in a form-locking manner, with respect to the rotor hub (9a) or the transmission input shaft (6), the inner guide element (38) accommodating the rotor hub (9a); and
an outer guide element (37) guidable, in a form-locking manner, at the transmission housing (1),
wherein the inner and outer guide elements (37 and 38) are radially spaced apart from each other and are fixed to each other with at least one radially extending connecting element (39),
wherein at least one sliding member (30) is longitudinally displaceably guided in the at least one radially extending connecting element (39), and the at least one sliding member (30) comprises two sliding member parts (31 and 32), which are adjustable with respect to each other,
wherein a first, radially outer sliding member part (31) of the two sliding member parts (31 and 32) is configured for form-locking engagement at an outer circumference of the stator (4), and a second, radially inner sliding member part (32) of the two sliding member parts (31 and 32) is configured for engagement at an end face (27) of the stator (4).

13. The assembly device of claim 12, wherein centering pins (41) extend axially from the outer guide element (37), and the centering pins (41) are configured for engagement in through-bores (14) of the transmission housing (1), which extend in a mounting flange formed at the transmission housing (1).

14. The assembly device of claim 12, wherein the second sliding member part (32) is configured for form-locking engagement into the end face (27) such that the stator (4), in a certain rotational position relative to the transmission housing (1), is accommodated by the assembly device (29) and is insertable into the transmission housing (1).

15. The assembly device of claim 14, wherein the second sliding member part (32) comprises positioning pins (33) extending in an axial direction, and the positioning pins (33) are configured for engagement in centering bore holes (28) of the stator (4).

16. The assembly device of claim 12, wherein the first sliding member part (31) is couplable to a driving surface (27) provided at the outer circumference of the stator (4).

17. The assembly device of claim 12, wherein the first sliding member part (31) and the second sliding member part (32) are each a hollow-cylindrical, the second sliding member part (32) is displaceably guided in the first sliding member part (31), and claws (34, 35) extend axially from the first sliding member part (31).

18. A hybrid drive module (2) and an assembly device (29) for inserting a stator (4) of an electric machine (3) of a hybrid drive module (2) into a bell-shaped transmission housing (1), the bell-shaped transmission housing (1) radially surrounding the hybrid drive module (2), a rotor (5) of the electric machine (3) at least indirectly connected to a transmission input shaft (6) via a rotor carrier (9) and a rotor hub (9a), a stator (4) of the electric machine (3) extending concentrically to the rotor (5), radially surrounding the rotor (5), and secured at the transmission housing (1), the assembly device (29) comprising:
an inner guide element (38) guidable, during an assembly process, in a form-locking manner with respect to the rotor hub (9a) or the transmission input shaft (6), the inner guide element (38) accommodating the rotor hub (9a); and
an outer guide element (37) configured to guide the assembly device (29) is guided in a form-locking manner at the transmission housing (1),
wherein the inner and outer guide elements (37 and 38) are radially spaced apart from each other and are fixed to each other with at least one radially extending connecting element (39),
wherein at least one sliding member (30) is a claw (34, 35), is longitudinally displaceably guided in the connecting element (39), accommodates the stator (4), and is configured to guide the stator (4) with respect to the rotor hub (9a) and the transmission input shaft (6) as well as with respect to the transmission housing (1).

19. The hybrid drive module and the assembly device of claim 18, wherein:
the sliding member (30) comprises two sliding member parts (31 and 32), which are adjustable with respect to each other;
a first, radially outer sliding member part (31) of the two sliding member parts (31 and 32) engages in a form-locking manner at the outer circumference of the stator (4); and
a second, radially inner sliding member part (32) of the two sliding member parts (31 and 32) engages at an end face (27) of the stator (4).

20. The hybrid drive module and the assembly device of claim 19, wherein:
the stator (4) comprises bulges (21) at an external shell surface of the stator (4);
the bulges (21) extend across a substantial portion of an axial length of the stator (4) and forming bolt-on surfaces (21a) at rear-side ends of the bulges (21);
tabs (26) extend in a circumferential direction and protrude from a front section of the bulges (21); and
the tabs (26) are each engaged from behind at a driving surface (27) by the first sliding member part (31).

21. The hybrid drive module and the assembly device of claim 20, wherein the tabs (26) comprise centering bore holes (28) extending in an axial direction, and positioning pins (33) of the second sliding member part (32) and locating pins (43) extending from the transmission housing (1) engage into the bore holes (28) in the mounted condition of the stator (4) during the assembly process.

22. A method for mounting a stator (4) of an electric machine (3) of a hybrid drive module (2) into a bell-shaped transmission housing (1), a rotor (5) of the electric machine (3) inserted into the bell-shaped transmission housing (1), the method comprising:
grasping the stator (4) by two sliding member parts (31 and 32) of an assembly device (29) at an end face and at a driving surface (27) provided at an outer circumference of the stator (4);
aligning the assembly device (29) in a radial direction as well as in a circumferential direction with respect to the assembly device (29);
centering the assembly device (29) in front of an end of the transmission housing (1);
aligning an outer guide element (37) via bore holes (14) provided in a flange of the transmission housing (1); and
centering one or both of a rotor hub (9a) and a transmission input shaft (6) at an inner guide element (38);
with a sliding member (30) formed by the two sliding member parts (31 and 32), displacing the stator (30) into a radial space between the rotor (4) and the transmission housing (1) until centering bore holes (28) provided at the stator (4) slide onto centering pins (43) protruding from the transmission housing (1);
bolting the stator (4) to the transmission housing (1) with axially extending bolts (22); and
separating the assembly device (29) from the stator (4) and, thereafter, from the transmission housing (1) and the one or both of the rotor hub (9a) and the transmission input shaft (6).
